(19) United States
(12) Patent Application Publication
(10) Pub. No.: US 2018/0244219 A1
(43) Pub. Date: Aug. 30, 2018

(54) PROTECTOR

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventor: Yuuki Sugisawa, Yokkaichi, Mie (JP)

(21) Appl. No.: 15/754,633

(22) PCT Filed: Aug. 29, 2016
(86) PCT No.: PCT/JP2016/075176

§ 371 Date: Feb. 23, 2018

(30) Foreign Application Priority Data
Sep. 1, 2015 (JP) 2015-172288

(51) Int. Cl. B60R 16/02; H02H 7/22; H02H 1/00

(52) U.S. Cl. CPC B60R 16/0215; H01H 85/0241; H02H 1/0007; H02H 7/226

(57) ABSTRACT

A protector is provided on an electric wire that is connected to first and second in-vehicle devices, and protects the first and second in-vehicle devices from a DC overcurrent that flows bi-directionally through the electric wire. The protector includes a thermal fuse, which is provided at a midpoint of the electric wire, and a current restrictor for restricting a current that flows therethrough, in accordance with the direction in which the current flows through the electric wire, the current restrictor being connected in parallel to the thermal fuse.

### PROTECTOR

This application is the U.S. national stage of PCT/JP2016/075176 filed Aug. 29, 2016, which claims priority of Japanese Patent Application No. JP 2015-172288 filed Sep. 1, 2015.

### TECHNICAL FIELD

The present invention relates to a protector that is to be provided on an electric wire connected to a plurality of in-vehicle devices, and protects these in-vehicle devices from a DC overcurrent that flows bi-directionally through the electric wire.

### BACKGROUND

A plurality of in-vehicle devices, e.g. loads such as a headlight and a motor, a storage battery, and a generator are connected to one another via electric wires in a vehicle. A thermal fuse is provided on the electric wires in order to prevent the electric wires or the in-vehicle devices from being damaged by an overcurrent.

However, conventional conditions under which the thermal fuse blows do not depend on the current flow direction, and are determined only based on the absolute value of the current.

The invention of the present application aims to provide a protector that is able to switch the condition under which a thermal fuse, which is provided on an electric wire connected to a plurality of in-vehicle devices, blows, in accordance with a current flow direction.

### SUMMARY

A protector according to an aspect of the present invention is a protector that is to be provided on an electric wire connected to a plurality of in-vehicle devices and protects the in-vehicle devices from a DC overcurrent flowing bi-directionally through the electric wire, the protector including: a thermal fuse provided at a midpoint of the electric wire; and a current restrictor for restricting a current that flows therethrough, in accordance with a direction in which the current flows through the electric wire, the current restrictor being connected in parallel to the thermal fuse.

Note that the present application can not only be realized as a protector that includes the above-described characteristic processor, but can also be realized as a protection method that includes the above-described characteristic processes as steps, and can also be realized as a program for causing a computer to execute those steps. The present application can also be realized as a semiconductor integrated circuit that realizes part of or the entire protector, or as any other kind of system that includes the protector.

### Advantageous Effects of Invention

According to the above, it is possible to provide a protector that is able to switch the condition under which a thermal fuse, which is provided on an electric wire connected to a plurality of in-vehicle devices, blows, in accordance with a current flow direction.

### BRIEF DESCRIPTION OF DRAWINGS

FIG. 1 is a circuit block diagram showing an exemplary configuration of a protection system according to Embodiment 1 of the present invention.

FIG. 2 is a circuit block diagram showing an operational state when a current flows from a second in-vehicle device to a first in-vehicle device.

FIG. 3 is a circuit block diagram showing an operational state when a current flows from the first in-vehicle device to the second in-vehicle device.

FIG. 4 is a circuit block diagram showing an exemplary configuration of a protection system according to a modification.

FIG. 5 is a circuit block diagram showing an exemplary configuration of a protection system according to Embodiment 2 of the present invention.

FIG. 6 is a circuit block diagram showing an exemplary configuration of a protection system according to Embodiment 3 of the present invention.

### DETAILED DESCRIPTION OF PREFERRED EMBODIMENTS

First, embodiments of the present invention will be listed. At least some of the following embodiments may also be combined in any manner.

A protector according to an aspect of the present invention is a protector that is to be provided on an electric wire connected to a plurality of in-vehicle devices and protects the in-vehicle devices from a DC overcurrent flowing bi-directionally through the electric wire, the protector including: a thermal fuse provided at a midpoint of the electric wire; and a current restrictor for restricting a current that flows therethrough, in accordance with a direction in which the current flows through the electric wire, the current restrictor being connected in parallel to the thermal fuse.

In the present application, the thermal fuse and the current restrictor are connected in parallel by the electric wire. The current restrictor restricts the current that flows through the current restrictor, in accordance with the current flow direction. For example, if the direction in which the current flows through the electric wire is a first direction, the current that flows through the current restrictor is restricted, and the current flows mainly through the thermal fuse. On the other hand, if the direction in which the current flows through the electric wire is a second direction, the current that flows through the current restrictor is not restricted, and the current flows through both the thermal fuse and the current restrictor.

Accordingly, the current that flows through the thermal fuse changes in accordance with the direction in which the current flows through the electric wire. As a result, the condition under which the thermal fuse blows is switched in accordance with the direction in which the current flows through the electric wire.

A configuration is preferable in which the current restrictor is a switch connected in parallel to the thermal fuse, and the protector further includes a control circuit for detecting a direction in which a current flows through the electric wire and opening or closing the switch in accordance with the direction of the current.

In the present application, the current restrictor is constituted by a switch, and the current that flows through this switch is restricted by opening or closing the switch. When the switch is open, the current flows mainly through the thermal fuse. When the switch is closed, the current flows through both the thermal fuse and the switch. The control circuit opens or closes the switch in accordance with the direction in which the current flows through the electric wire, and changes the current that flows through the thermal fuse.

Accordingly, the condition under which the thermal fuse blows is switched in accordance with the direction in which the current flows through the electric wire.

A configuration is preferable in which the switch is a semiconductor switch, the control circuit includes a comparator circuit for comparing a voltage at one end portion of the fuse with a voltage at the other end portion of the fuse, and outputting a signal corresponding to a comparison result to the semiconductor switch, and the semiconductor switch opens or closes in accordance with the signal output from the comparator circuit.

In the present application, the direction in which the current flows through the electric wire is detected by the comparator circuit, and the comparator circuit outputs, to the semiconductor switch, different signals corresponding to the current flow direction. The semiconductor switch opens or closes in accordance with the signal output from the comparator circuit.

Accordingly, it is possible, without a control device such as a microcomputer, to automatically open or close the semiconductor switch in accordance with the direction in which the current flows through the electric wire, and switch the condition under which the thermal fuse blows, in accordance with the direction in which the current flows through the electric wire.

A configuration is preferable in which the comparator circuit has hysteresis.

In the present application, the comparator circuit has hysteresis. Accordingly, when, for example, the current value has decreased, an oscillation phenomenon in which a high-level signal and a low-level signal are repeatedly output from the comparator circuit can be prevented.

A configuration is preferable in which the switch is a MOSFET (metal-oxide-semiconductor field-effect transistor) having a parasitic diode, and the control circuit opens the switch if the direction in which the current flows through the electric wire is the same as a forward direction of the parasitic diode, and closes the switch if the direction in which the current flows through the electric wire is opposite to the forward direction of the parasitic diode.

In the present application, the switch is constituted by a MOSFET that has little power loss, and the current that flows through the thermal fuse can be changed by opening or closing the MOSFET. Accordingly, the condition under which the thermal fuse blows can be switched in accordance with the direction of the current flow in the electric wire in a circuit with low power consumption.

It is also preferable to use a MOSFET that contains an overcurrent protection circuit. This is because an overcurrent may also flow through the MOSFET if the thermal fuse has blown. The MOSFET that contains an overcurrent protection circuit enters a closed state if an overcurrent flows therethrough.

A configuration is preferable in which the protector further includes: a blowout detector for detecting blowout of the thermal fuse; and an output unit for outputting predetermined information if the blowout detector detects blowout.

In the present application, if the thermal fuse has blown, the output unit can output the predetermined information. For example, a notification that the thermal fuse has blown can be given to the outside.

### DETAILS OF EMBODIMENTS OF THE PRESENT INVENTION

Specific examples of a protection system according to the embodiments of the present invention will be described below with reference to the drawings. Note that the present invention is not limited to these examples but is described in the claims, and is intended to encompass meanings equivalent to the claims and all modifications within the scope of claims.

### Embodiment 1

Hereinafter, the present invention will be described in detail based on the drawings showing the embodiment.

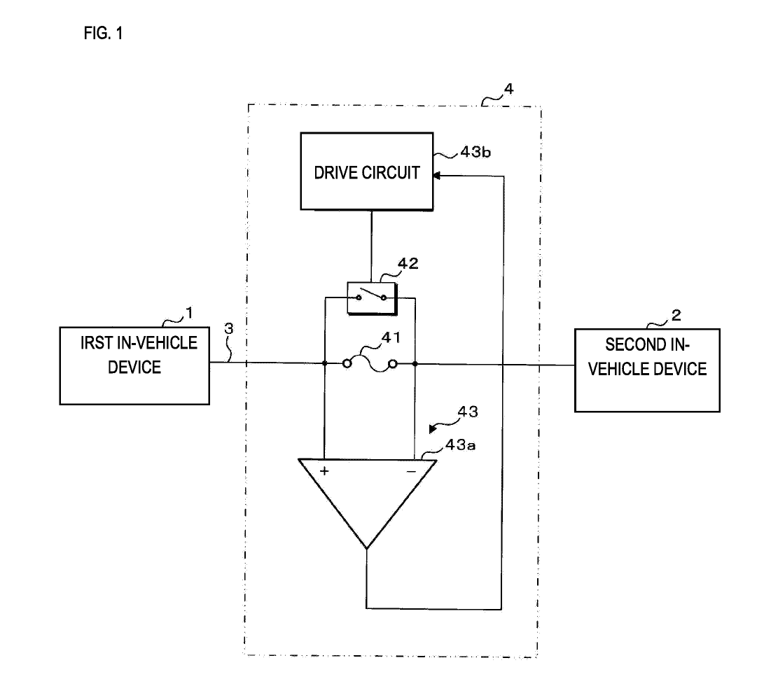

FIG. 1 is a circuit block diagram showing an exemplary configuration of a protection system according to Embodiment 1 of the present invention. The protection system includes a first in-vehicle device 1 and a second in-vehicle device 2, which are connected to each other by an electric wire 3, and a protector 4 that is provided on the electric wire 3 and protects the first and second in-vehicle devices 1 and 2 from a DC overcurrent that flows bi-directionally through the electric wire 3.

Each of the first and second in-vehicle devices 1 and 2 is any one of a load, an in-vehicle power source, a generator, and the like that are mounted on a vehicle. For example, the load is a headlight, a wiper, or the like. For example, the in-vehicle power source is a lithium-ion battery, a lead storage battery, a nickel metal hydride battery, or any kind of capacitor. The generator is an alternator that is driven by a gasoline engine and generates power. Depending on the operational situation, a DC current may flow from the first in-vehicle device 1 to the second in-vehicle device 2, or a DC current may also flow from the second in-vehicle device 2 to the first in-vehicle device 1, through the electric wire 3 that connects the first in-vehicle device 1 and the second in-vehicle device 2 to each other.

The protector 4 includes a thermal fuse 41, which is provided at a midpoint of the electric wire 3, and a switch 42, which is connected in parallel to the thermal fuse 41 and opens and closes in accordance with the direction in which the current flows through the electric wire 3. The switch 42 is an example of a current restrictor for restricting the current that flows therethrough, in accordance with the direction in which the current flows through the electric wire 3. For example, the switch 42 is a mechanical switch, a mechanical relay, or a semiconductor switch. A first end portion of the switch 42 is connected to the electric wire 3 on the first in-vehicle device 1 side, and a second end portion of the switch 42 is connected to the electric wire 3 on the second in-vehicle device 2 side. The switch 42 is provided with a control terminal, to which a signal for opening or closing the switch 42 is input. The switch 42 opens if a positive potential is applied to the control terminal, and the switch 42 closes if a negative potential is applied thereto. A MOSFET, an IGBT (Insulated Gate Bipolar Transistor), an IPS (Intelligent Power Switch), or the like, may be used as the semiconductor switch.

The switch 42 also contains an overcurrent protection circuit. If an overcurrent flows through the switch 42 that contains the overcurrent protection circuit, the switch 42 automatically enters a closed state. Although the value of the overcurrent that causes the switch to enter the closed state is not particularly limited, a setting may be configured so that, if the thermal fuse 41 does not blow in a state where the current is diverted to the thermal fuse 41 and the switch 42, the overcurrent protection circuit in the switch 42 does not work either.

The protector 4 also includes a control circuit 43 for detecting the direction of the current flowing through the electric wire 3, and opening or closing the switch 42 in accordance with this current direction. The control circuit 43 includes a comparator circuit 43a for comparing the voltage at a first end portion of the thermal fuse 41 with the voltage at a second end portion of the thermal fuse 41, and outputting a signal corresponding to the comparison result, and a drive circuit 43b for opening or closing the switch 42 in accordance with the signal output from the comparator circuit 43a. Specifically, the comparator circuit 43a is a differential amplifier whose non-inverting input terminal and inverting input terminal are connected, respectively, to the first end portion of the thermal fuse 41 that is connected to the electric wire 3 on the first in-vehicle device 1 side, and to the second end portion of the thermal fuse 41 that is connected to the electric wire 3 on the second in-vehicle device 2 side. An output terminal of the differential amplifier is connected to an input terminal of the drive circuit 43b. If the potential on the first in-vehicle device 1 side is higher than the potential on the second in-vehicle device 2 side, the comparator circuit 43a outputs a current from the output terminal. If the potential on the second in-vehicle device 2 side is higher than the potential on the first in-vehicle device 1 side, a current is drawn to the output terminal. The drive circuit 43b, whose output terminal is connected to the control terminal of the switch 42, converts a current signal output from the comparator circuit 43a to a voltage signal, and outputs this voltage signal to the control terminal of the switch 42. That is to say, if a current is output from the output terminal of the comparator circuit 43a, the drive circuit 43b applies a positive-potential signal to the control terminal of the switch 42. If a current is drawn to the output terminal of the comparator circuit 43a, the drive circuit 43b applies a negative-potential signal to the control terminal of the switch 42.

Next, operations of the configured protector 4 will be described.

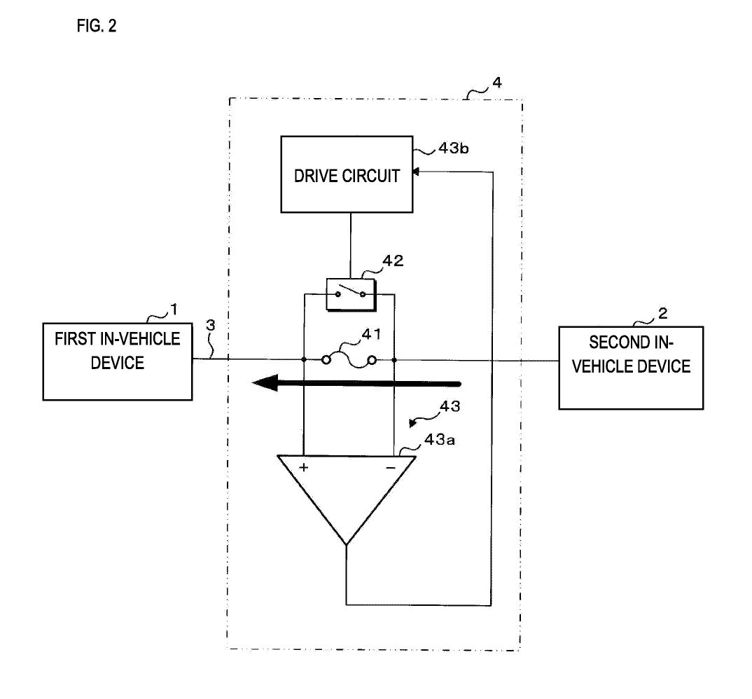

FIG. 2 is a circuit block diagram showing an operational state when a current flows from the second in-vehicle device 2 to the first in-vehicle device 1. When a current flows from the second in-vehicle device 2 to the first in-vehicle device 1, of the potentials at both ends of the thermal fuse 41, the potential on the second in-vehicle device 2 side is higher than the potential on the first in-vehicle device 1 side. Accordingly, the drive circuit 43b applies a negative-potential signal to the switch 42. The switch 42 to which the negative-potential signal is applied enters an open state. As a result, the current flows from the second in-vehicle device 2 to the first in-vehicle device 1 via the thermal fuse 41.

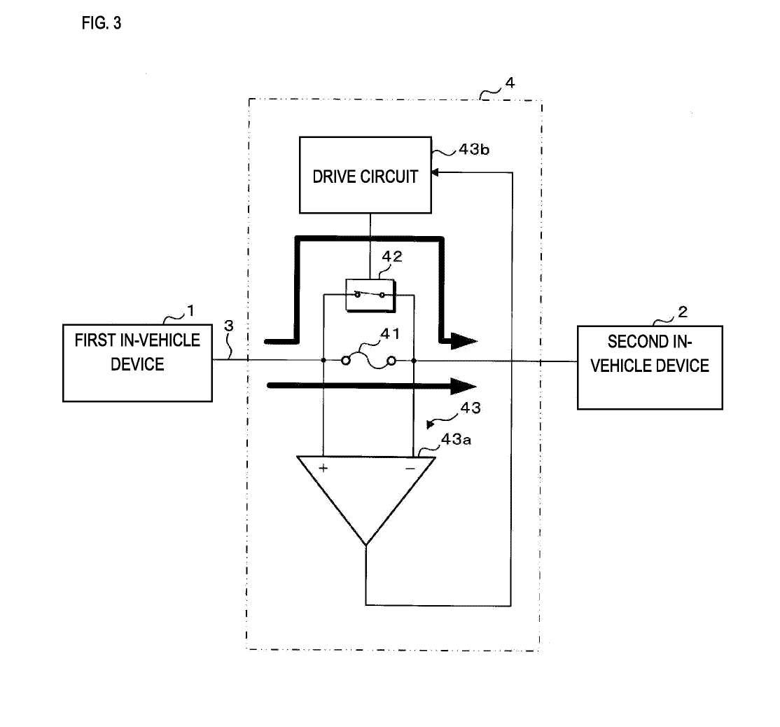

FIG. 3 is a circuit block diagram showing an operational state when a current flows from the first in-vehicle device 1 to the second in-vehicle device 2. When a current flows from the first in-vehicle device 1 to the second in-vehicle device 2, of the potentials at both ends of the thermal fuse 41, the potential on the first in-vehicle device 1 side is higher than the potential on the second in-vehicle device 2 side. Accordingly, the drive circuit 43b applies a positive-potential signal to the switch 42. The switch 42 to which the positive-potential signal is applied enters a closed state. As a result, the current is diverted from the first in-vehicle device 1 to the thermal fuse 41 and the switch 42, and then flows to the second in-vehicle device 2.

As mentioned above, when a current flows from the first in-vehicle device 1 to the second in-vehicle device 2, a portion of the current that flows through the electric wire 3 flows through the switch 42. For this reason, the fusing current of the thermal fuse 41 at this time is greater than when a current flows from the second in-vehicle device 2 to the first in-vehicle device 1.

For example, it is assumed that the electrical resistance and fusing current of the thermal fuse 41 are 1 mΩ and 30 A, respectively, and the electrical resistance of the switch 42 is 1 mΩ. As shown in FIG. 3, when a current is flowing from the first in-vehicle device 1 to the second in-vehicle device 2, the current that flows through the electric wire 3 is diverted to the thermal fuse 41 and the switch 42 at a ratio of 1:1, and accordingly, a current of up to 60 A can flow. If a current of 60 A or greater flows through the electric wire 3, a current of 30 A flows through the thermal fuse 41, and the thermal fuse 41 blows.

As shown in FIG. 2, when a current is flowing from the second in-vehicle device 2 to the first in-vehicle device 1, the current that flows through the electric wire 3 entirely flows through the thermal fuse 41, and accordingly, a current of up to 30 A can flow. If a current of 30 A or greater flows through the electric wire 3, a current of 30 A flows through the thermal fuse 41, and the thermal fuse 41 blows.

With the thus-configured protector 4 according to Embodiment 1, it is possible to automatically switch the condition under which the thermal fuse 41, which is provided on the electric wire 3 that connects the first and second in-vehicle devices 1 and 2, blows, in accordance with the current flow direction.

In addition, the condition under which the thermal fuse 41 blows can be switched in accordance with the current flow direction, with a simple configuration in which the switch 42 connected in parallel to the thermal fuse 41 is opened and closed.

Furthermore, the protector 4 is configured to open or close the switch 42 using the comparator circuit 43a and the drive circuit 43b, which are analog circuits. For this reason, the switch 42 can be automatically opened or closed in accordance with the direction in which the current flows through the electric wire 3, and the condition under which the thermal fuse 41 blows can be switched, without any control device such as a microcomputer.

Furthermore, even if the thermal fuse 41 has blown due to an overcurrent, a current can flow only in a direction from the first in-vehicle device 1 toward the second in-vehicle device 2.

Furthermore, if an overcurrent flows through the switch 42 after the thermal fuse 41 has blown due to the overcurrent, the switch 42 enters a closed state. Accordingly, the first and second in-vehicle devices 1 and 2 can be protected from the overcurrent.

Note that the above embodiment has described an example in which one thermal fuse 41 and one switch 42 are connected in parallel to each other. However, a configuration may also be employed in which a first series circuit, in which a first thermal fuse and a switch are connected in series to each other, and a second series circuit, in which a second thermal fuse having a fusing current that is different from that of the first thermal fuse and a switch are connected in series to each other, are connected in parallel to each other, and the switches in the first and second series circuits are selectively opened or closed in accordance with the direction in which the current flows through the electric wire.

A configuration may also be employed in which a first thermal fuse and a second thermal fuse, which have different fusing currents, are connected in parallel to each other, a switch is connected in series to one of these thermal fuses, and this switch is opened or closed in accordance with the direction in which the current flows through the electric wire.

### Modification

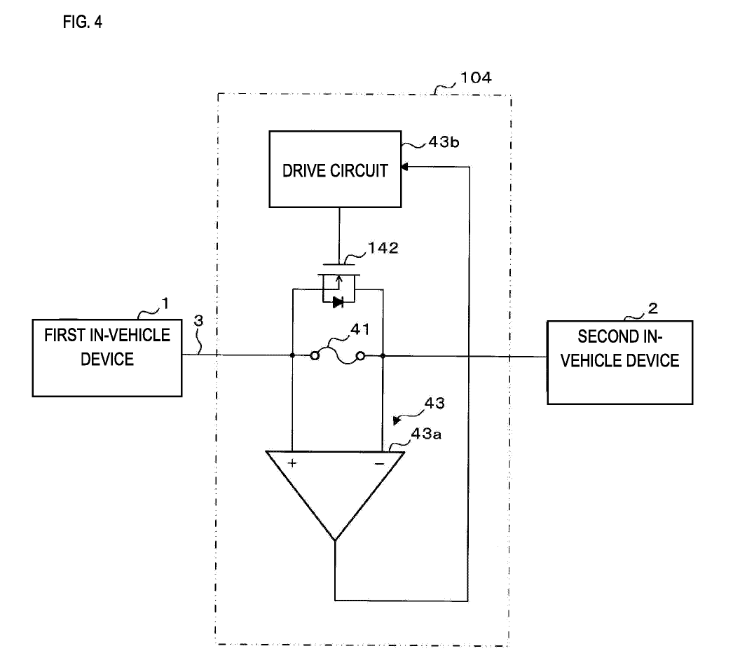

FIG. 4 is a circuit block diagram showing an exemplary configuration of a protection system according to a modification. Embodiment 1 has described the configuration of the switch 42 as a typical element in which a path through which a current flows is opened or closed. Meanwhile, if the switch 42 is constituted by a MOSFET 142, the following configuration may be employed. A protector 104 according to the modification includes an N-channel MOSFET 142 as the switch. A drain of the MOSFET 142 is connected to the electric wire 3 on the second in-vehicle device 2 side, and a source of the MOSFET 142 is connected to the electric wire 3 on the first in-vehicle device 1 side. A gate of the MOSFET 142 is connected to the drive circuit 43b.

The MOSFET 142 has a parasitic diode, and the forward direction of the parasitic diode of the MOSFET 142 is the direction in which the current flows from the first in-vehicle device 1 to the second in-vehicle device 2. If, in the thus-connected MOSFET 142, the direction in which the current flows through the electric wire 3 is the same as the forward direction of the parasitic diode, the MOSFET 142 enters an open state. If the direction in which the current flows through the electric current 3 is opposite to the forward direction of the parasitic diode, the MOSFET 142 enters a closed state.

The MOSFET 142 according to the modification may also include an overcurrent protection circuit similar to that in Embodiment 1.

With the protector 104 according to the modification, the condition under which the thermal fuse 41 blows can be switched in accordance with the current flow direction, using the MOSFET 142 that has little power loss.

When a current flows from the first in-vehicle device 1 to the second in-vehicle device 2, the current also flows through the parasitic diode. However, power loss can be reduced by closing the MOSFET 142.

### Embodiment 2

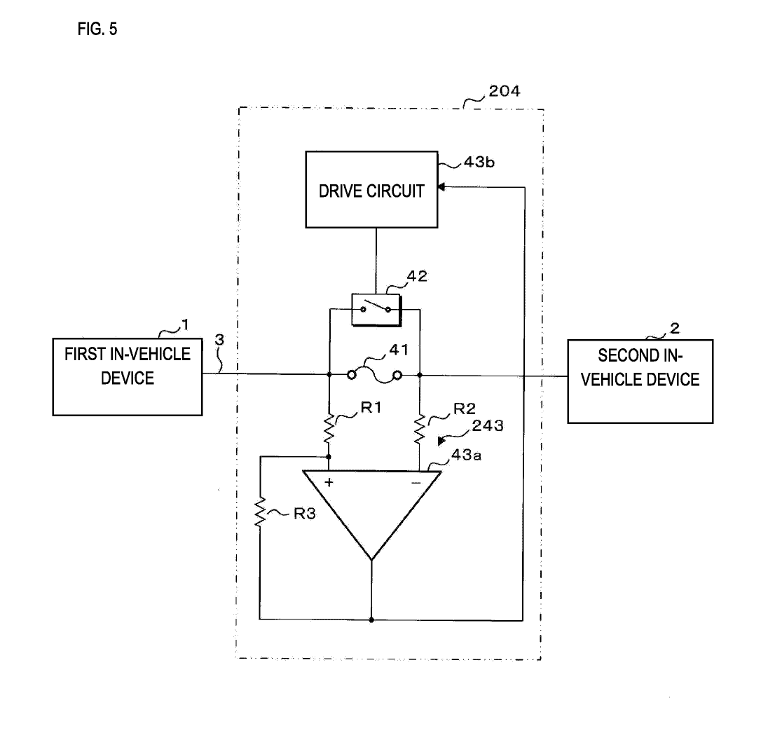

FIG. 5 is a circuit block diagram showing an exemplary configuration of a protection system according to Embodiment 2 of the present invention. The protection system according to Embodiment 2 has a control circuit 243 with a configuration that is different from that in Embodiment 1. Mainly this difference will be described below.

The comparator circuit 43a in the protector 204 according to Embodiment 2 has hysteresis due to positive feedback. Specifically, a first end of a resistor R1 is connected to the first end portion of the thermal fuse 41 that is connected to the electric wire 3 on the first in-vehicle device 1 side, and the non-inverting input terminal of the comparator circuit 43a is connected to a second end of the resistor R1. A first end of a resistor R2 is connected to the second end portion of the thermal fuse 41 that is connected to the electric wire 3 on the second in-vehicle device 2 side, and the inverting input terminal of the comparator circuit 43a is connected to a second end of the resistor R2. A first end of a resistor R3 is connected to the output terminal of the comparator circuit 43a, and a second end of the resistor R3 is connected to the non-inverting input terminal.

With the thus-configured protector 204, when the switch 42 is in an open state, the output of the comparator circuit 43a does not switch and the switch 42 does not enter a closed state unless the potential at the non-inverting input terminal is higher than the potential at the inverting input terminal by the potential corresponding to hysteresis. Similarly, when the switch 42 is in a closed state, the output of the comparator circuit 43a does not switch and the switch 42 does not enter an open state unless the potential at the inverting input terminal is higher than the potential at the non-inverting input terminal by the potential corresponding to hysteresis.

With the protector 204 according to Embodiment 2, the comparator circuit 43a has hysteresis. Accordingly, when the current value has decreased, an oscillation phenomenon in which a high-level signal and a low-level signal are repeatedly output from the comparator circuit 43a can be prevented.

### Embodiment 3

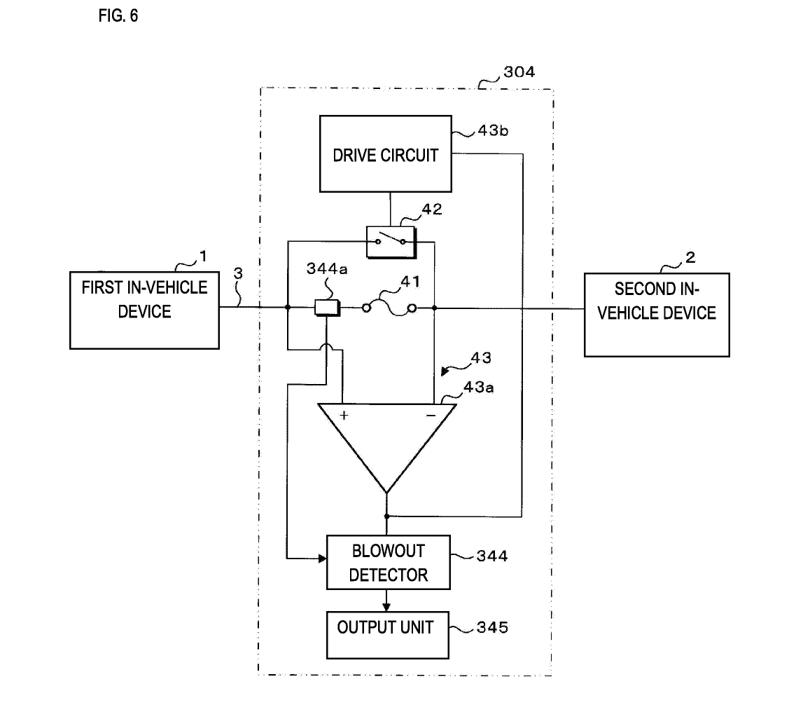

FIG. 6 is a circuit block diagram showing an exemplary configuration of a protection system according to Embodiment 3 of the present invention. The protection system according to Embodiment 3 is different from Embodiment 1 in that a structure for giving a notification of blowout of the thermal fuse 41 is further provided. Mainly this difference will be described below.

A protector 304 according to Embodiment 3 includes the thermal fuse 41, the switch 42, and the control circuit 43, similar to Embodiment 1, and further includes a blowout detector 344 and an output unit 345. For example, the blowout detector 344 is a current sensor for detecting a current that flows through the electric wire 3. The blowout detector 344 includes a shunt resistor 344a, which is connected in series to the thermal fuse 41. A first end portion of the switch 42 is connected to a first end of a series circuit constituted by the shunt resistor 344a and the thermal fuse 41, and a second end portion of the switch 42 is connected to a second end of this series circuit. The blowout detector 344 detects whether or not a current is flowing through the aforementioned series circuit, by detecting the voltage across the shunt resistor 344a. The output terminal of the comparator circuit 43a is connected to the blowout detector 344, and the blowout detector 344 determines whether or not a voltage is applied across the thermal fuse 41, based on the signal output from the output terminal of the comparator circuit 43a. If a current is not flowing through the series circuit even though a voltage is applied across the series circuit, the blowout detector 344 gives a predetermined signal to the output unit 345.

If the predetermined signal output from the blowout detector 344 is input to the output unit 345, the output unit 345 outputs predetermined information to the outside. For example, the output unit 345 is a speaker, a display, a warning lamp, or the like. The output unit outputs the fact that the thermal fuse 41 has blown, by means of sound, light, or the like.

Note that the output unit 345 may also be an in-vehicle LAN communication device that is connected to an external ECU. The output unit 345 transmits, to the external ECU, information indicating that the thermal fuse 41 has blown, in accordance with the detection result from the blowout detector 344. The external ECU is a control device for controlling operations of the speaker, a display, a warning lamp, or the like, receives the information output from the output unit 345, and causes the information to be output by means of sound, light, or the like, in accordance with the content of the received information.

With the protector 304 according to Embodiment 3 that is configured as described above, a notification that the thermal fuse 41 has blown can be given to the outside.

1. A protector that is to be provided on an electric wire connected to a plurality of in-vehicle devices and protects the in-vehicle devices from a DC overcurrent flowing bi-directionally through the electric wire, the protector comprising:
a thermal fuse provided at a midpoint of the electric wire; and
a current restrictor for restricting a current that flows therethrough, in accordance with a direction in which the current flows through the electric wire, the current restrictor being connected in parallel to the thermal fuse,
wherein the current restrictor is a switch that is connected in parallel to the thermal fuse and reversibly opens and closes, and
the protector further comprises a control circuit for detecting a direction in which a current flows through the electric wire and opening or closing the switch in accordance with the direction of the current.

2. (canceled)

3. The protector according to claim 1,
wherein the switch is a semiconductor switch,
the control circuit includes a comparator circuit for comparing a voltage at one end portion of the thermal fuse with a voltage at the other end portion of the thermal fuse, and outputting a signal corresponding to a comparison result to the semiconductor switch, and
the semiconductor switch opens or closes in accordance with the signal output from the comparator circuit.

4. The protector according to claim 3,
wherein the comparator circuit has hysteresis.

5. The protector according to claim 1,
wherein the switch is a MOSFET having a parasitic diode, and
the control circuit opens the switch if the direction in which the current flows through the electric wire is the same as a forward direction of the parasitic diode, and closes the switch if the direction in which the current flows through the electric wire is opposite to the forward direction of the parasitic diode.

6. The protector according to claim 1, further comprising:
a blowout detector for detecting blowout of the thermal fuse; and
an output unit for outputting predetermined information if the blowout detector detects blowout.

7. The protector according to claim 3, wherein the switch is a MOSFET having a parasitic diode, and the control circuit opens the switch if the direction in which the current flows through the electric wire is the same as a forward direction of the parasitic diode, and closes the switch if the direction in which the current flows through the electric wire is opposite to the forward direction of the parasitic diode.

8. The protector according to claim 4, wherein the switch is a MOSFET having a parasitic diode, and the control circuit opens the switch if the direction in which the current flows through the electric wire is the same as a forward direction of the parasitic diode, and closes the switch if the direction in which the current flows through the electric wire is opposite to the forward direction of the parasitic diode.

9. The protector according to claim 3, further comprising:
a blowout detector for detecting blowout of the thermal fuse; and
an output unit for outputting predetermined information if the blowout detector detects blowout.

10. The protector according to claim 4, further comprising:
a blowout detector for detecting blowout of the thermal fuse; and
an output unit for outputting predetermined information if the blowout detector detects blowout.

11. The protector according to claim 5, further comprising:
a blowout detector for detecting blowout of the thermal fuse; and
an output unit for outputting predetermined information if the blowout detector detects blowout.
